(19) United States
(12) Patent Application Publication
(10) Pub. No.: US 2023/0256635 A1
(43) Pub. Date: Aug. 17, 2023

(54) Razor Cleaning Assembly

(71) Applicant: Walter Glover, Tulsa, OK (US)

(72) Inventor: Walter Glover, Tulsa, OK (US)

(21) Appl. No.: 17/584,578

(22) Filed: Jan. 26, 2022

(51) Int. Cl. B26B 21/40; A45D 27/46

(52) U.S. Cl. CPC B26B 21/4062; A45D 27/46; B26B 21/4012

(57) ABSTRACT

A razor cleaning assembly includes a razor that has a head and a handle. The head has a plurality of razor blades being disposed within the head. A cleaning unit is movably integrated into the head of the razor. The cleaning unit has a plurality of pushing elements that is each positioned between respective pairs of the razor blades. The cleaning unit is actuatable into a cleaning position having each of the pushing elements traveling between the respective pair of razor blades. In this way each of the pushing elements can push hairs out from between the respective pair of razor blades. The cleaning unit is biased into a retracted position having each of the pushing elements being retracted from between the respective pair of razor blades.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### Field of the Invention

The disclosure relates to cleaning devices and more particularly pertains to a new cleaning device for cleaning hairs from a razor. The device includes a razor with a plurality of razor blades and a cleaning unit that is movably integrated into the razor. The cleaning unit includes a plurality of pushing elements that each travels between respective pairs of razor blades. Each of the pushing elements pushes hairs outwardly from between the respective pair of razor blades when the cleaning unit is actuated thereby facilitating the razor to be cleaned.

Description of Related Art including information disclosed under 37 CFR 1.97 and 1.98.

The prior art relates to cleaning devices including a razor cleaning device that includes a pair of buttons each being disposed on opposing lateral sides of a razor head and a cleaner that is movably integrated into the razor head for urging hairs outwardly from the razor when the buttons are depressed. The prior art discloses a variety of twin blade razors with a member that is slidably disposed between the twin blades for urging hair outwardly from between the twin blades. The prior art discloses a razor having a plurality of blades which can be moved apart from each other for cleaning between the plurality of blades.

### (H) BRIEF SUMMARY OF THE INVENTION

An embodiment of the disclosure meets the needs presented above by generally comprising a razor that has a head and a handle. The head has a plurality of razor blades being disposed within the head. A cleaning unit is movably integrated into the head of the razor. The cleaning unit has a plurality of pushing elements that is each positioned between respective pairs of the razor blades. The cleaning unit is actuatable into a cleaning position having each of the pushing elements traveling between the respective pair of razor blades. In this way each of the pushing elements can push hairs out from between the respective pair of razor blades. The cleaning unit is biased into a retracted position having each of the pushing elements being retracted from between the respective pair of razor blades.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### I BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is a front view of a razor cleaning assembly according to an embodiment of the disclosure.

FIG. 2 is a left side view of an embodiment of the disclosure.

FIG. 3 is a back view of an embodiment of the disclosure.

FIG. 4 is a back perspective view of an embodiment of the disclosure.

FIG. 5 is a left side cut-away view of an embodiment of the disclosure showing a cleaning unit in a retracted position.

FIG. 6 is a left side cut-away view of an embodiment of the disclosure showing a cleaning unit in a cleaning position.

### (J) DETAILED DESCRIPTION OF THE INVENTION

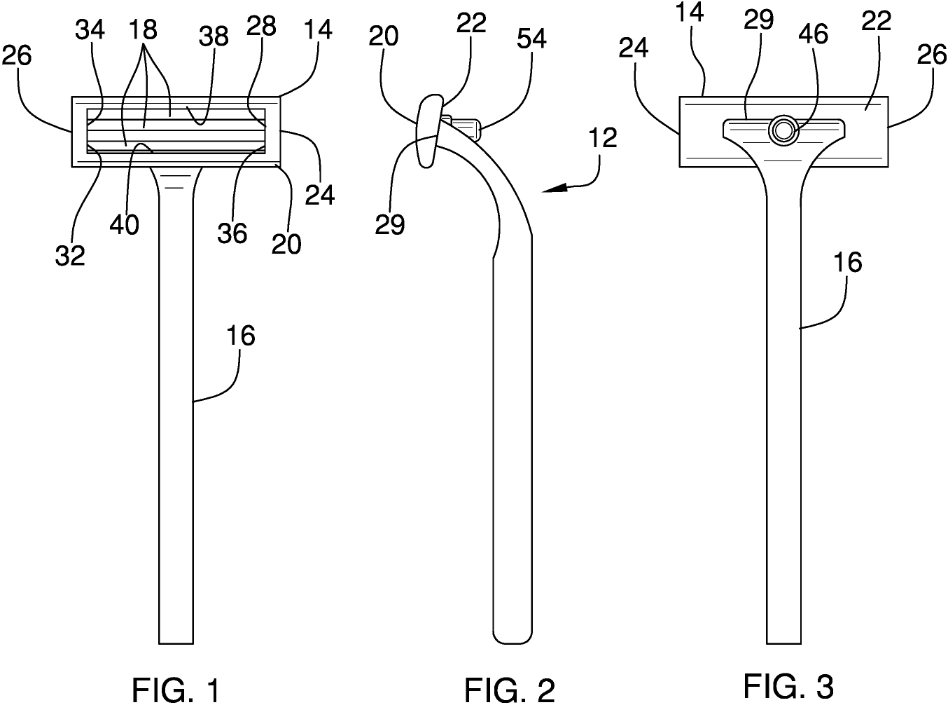

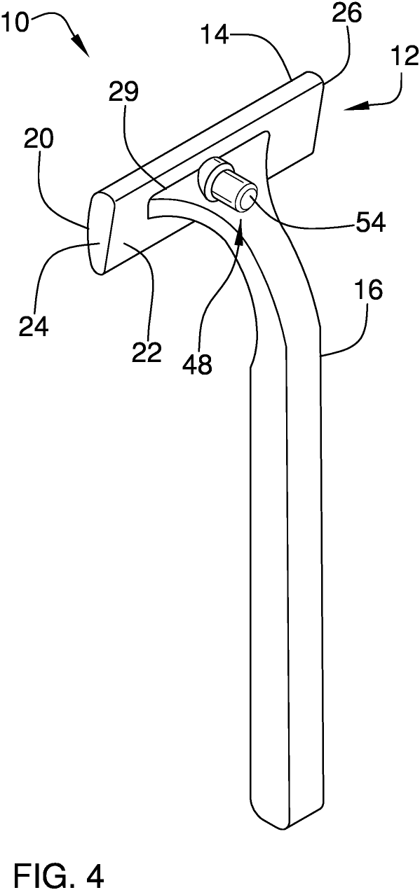

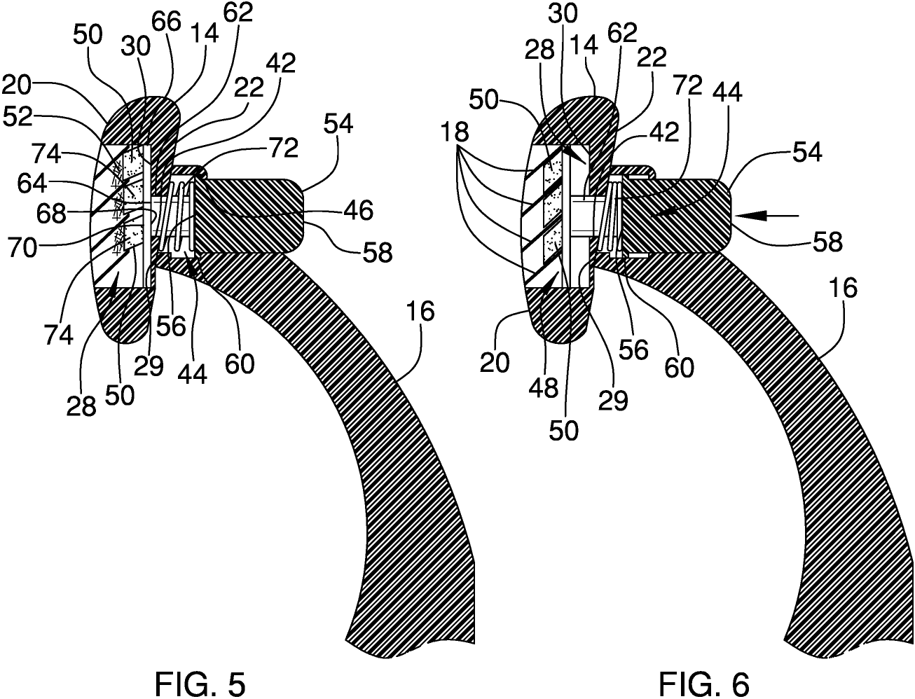

With reference now to the drawings, and in particular to FIGS. 1 through 6 thereof, a new cleaning device embodying the principles and concepts of an embodiment of the disclosure and generally designated by the reference numeral 10 will be described.

As best illustrated in FIGS. 1 through 6, the razor cleaning assembly 10 generally comprises a razor 12 that has a head 14 and a handle 16. The head 14 has a plurality of razor blades 18 each being disposed within the head 14. The head 14 has a front side 20, a back side 22, a first end 24 and a second end 26, and the front side 20 has a razor well 28 extending toward the back side 22. The razor well 28 is elongated to extend substantially between the first end 24 and the second end 26. The back side 22 is coupled to a top end 29 of the handle 16.

The razor well 28 has a lower bounding surface 30 and a lateral bounding surface 32, and the lateral bounding surface 32 has a first lateral side 34, a second lateral side 36, a top side 38 and a bottom side 40. Each of the razor blades 18 is positioned in the razor well 28 and each of the razor blades 18 extends between the first lateral side 34 and the second lateral side 36 of the lateral bounding surface 32. The razor blades 18 are spaced apart from each other and are distributed between the top side 38 and the bottom side 40 of the lateral bounding surface 32. The head 14 has an opening 42 extending through the back side 22 and intersecting the razor well 28. The top end 29 of the handle 16 has a button well 44 extending into the top end 29 and the button well 44 is aligned with the opening 42 in the back side 22 of the head 14. Additionally, the handle 16 has a hole 46 extending through the handle 16 and intersecting the button well 44.

A cleaning unit 48 is provided and the cleaning unit 48 is movably integrated into the head 14 of the razor 12. The cleaning unit 48 has a plurality of pushing elements 50 that is each positioned between respective pairs of the razor blades 18. The cleaning unit 48 is actuatable into a cleaning position having each of the pushing elements 50 traveling between the respective pair of razor blades 18. In this way each of the pushing elements 50 can push hairs 52 out from between the respective pair of razor blades 18. The cleaning unit 48 is biased into a retracted position having each of the pushing elements 50 being retracted from between the respective pair of razor blades 18.

The cleaning unit 48 comprises a button 54 is positioned in the hole 46 in the handle 16 and extending into the button well 44. The button 54 has a first end 56 and a second end 58, and the button 54 has a lip 60 extending laterally away from the button 54. The lip 60 is aligned with the first end 56 of the button 54 and the lip 60 is positioned in the button well 44. Furthermore, the lip 60 abuts a threshold between the button well 44 and the hole 46 thereby inhibiting the button 54 from being removed from the button well 44.

The cleaning unit 48 includes a stem 62 that is coupled to the first end 24 of the button 54 and extends through the opening 42 in the head 14. The stem 62 has a distal end 64 with respect to the first end 24 of the button 54. The cleaning unit 48 includes a panel 66 that has a first surface 68 and a second surface 70, and the first surface 68 is coupled to the distal end 64 of the stem 62 such that the panel 66 is positioned in the razor well 28. The cleaning unit 48 includes a biasing member 72 that is positioned around the stem 62 and the biasing member 72 extends between the back side 22 of the head 14 and the first end 24 of the button 54. The biasing member 72 biases the second end 26 of the button 54 outwardly through the hole 46 in the handle 16 such that the first surface 68 of the panel 66 rests against the lower bounding surface 30 of the razor well 28. Additionally, the panel 66 travels toward the front side 20 of the head 14 when the button 54 is depressed.

The cleaning unit 48 includes a plurality of cushions 74 that is each coupled to the second surface 70 of the panel 66. Each of the cushions 74 is positioned between respective pairs of the razor blades 18 such that each of the cushions 74 defines a respective one of the pushing elements 50. Each of the cushions 74 travels toward the front side 20 of the head 14 when the button 54 is depressed. In this way each of the cushions 74 can urge the hairs 52 toward the front side 20 of the head 14. Each of the cushions 74 is comprised of a deformable material such that the cushions 74 are inhibited from deforming the razor blades 18 when the button 54 is depressed.

In use, the button 54 is depressed to urge the cushions 74 to travel between the razor blades 18 for pushing hairs 52 outwardly from between the razor blades 18. In this way the razor 12 can be cleaned of hairs 52 in a more effective manner than the current method of simply rinsing existing razors. Thus, the service life of the razor 12 is enhanced to the fullest extent thereby saving time and money for a user. The cushions 74 are retracted into the head 14 when the button 54 is released thereby facilitating the razor 12 to be employed for shaving.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A razor cleaning assembly for removing hairs from between razor blades in a shaving razor, said assembly comprising:
a razor having a head and a handle, said head having a plurality of razor blades being disposed within said head; and
a cleaning unit being movably integrated into said head of said razor, said cleaning unit having a plurality of pushing elements each being positioned between respective pairs of said razor blades, said cleaning unit being actuatable into a cleaning position having each of said pushing elements traveling between said respective pair of razor blades wherein each of said pushing elements is configured to push hairs out from between said respective pair of razor blades, said cleaning unit being biased into a retracted position having each of said pushing elements being retracted from between said respective pair of razor blades.

2. The assembly according to claim 1, wherein:
said head has a front side, a back side, a first end and a second end;
said front side has a razor well extending toward said back side, said razor well being elongated to extend substantially between said first end and said second end, said back side being coupled to a top end of said handle, said razor well having a lower bounding surface and a lateral bounding surface, said lateral bounding surface having a first lateral side, a second lateral side, a top side and a bottom side, each of said razor blades being positioned in said razor well, each of said razor blades extending between said first lateral side and said second lateral side of said lateral bounding surface, said razor blades being spaced apart from each other and being distributed between said top side and said bottom side of said lateral bounding surface;
said head having an opening extending through said back side and intersecting said razor well;
said top end of said handle has a button well extending into said top end, said button well being aligned with said opening in said back side of said head; and
said handle has a hole extending through said handle and intersecting said button well.

3. The assembly according to claim 2, wherein said cleaning unit comprises a button being positioned in said hole in said handle and extending into said button well, said button having a first end and a second end, said button having a lip extending laterally away from said button, said lip being aligned with said first end, said lip being positioned in said button well, said lip abutting a threshold between said button well and said hole thereby inhibiting said button from being removed from said button well.

4. The assembly according to claim 3, wherein said cleaning unit includes a stem being coupled to said first end of said button and extending through said opening in said head, said stem having a distal end with respect to said first end of said button.

5. The assembly according to claim 4, wherein said cleaning unit includes a panel having a first surface and a second surface, said first surface being coupled to said distal end of said stem such that said panel is positioned in said razor well.

6. The assembly according to claim 5, wherein said cleaning unit includes a biasing member being positioned around said stem, said biasing member extending between said back side of said head and said first end of said button, said biasing member biasing said second end of said button outwardly through said hole in said handle such that said first surface of said panel rests against said lower bounding surface of said razor well, said panel travelling toward said front side of said head when said button is depressed.

7. The assembly according to claim 5, wherein said cleaning unit includes a plurality of cushions, each of said cushions being coupled to said second surface of said panel, each of said cushions being positioned between respective pairs of said razor blades such that each of said cushions defines a respective one of said pushing elements.

8. The assembly according to claim 7, wherein each of said cushions travels toward said front side of said head when said button is depressed wherein each of said cushions is configured to urge the hairs toward said front side of said head.

9. The assembly according to claim 7, wherein each of said cushions is comprised of a deformable material such that said cushions are inhibited from deforming said razor blades when said button is depressed.

10. A razor cleaning assembly for removing hairs from between razor blades in a shaving razor, said assembly comprising:
a razor having a head and a handle, said head having a plurality of razor blades being disposed within said head, said head having a front side, a back side, a first end and a second end, said front side having a razor well extending toward said back side, said razor well being elongated to extend substantially between said first end and said second end, said back side being coupled to a top end of said handle, said razor well having a lower bounding surface and a lateral bounding surface, said lateral bounding surface having a first lateral side, a second lateral side, a top side and a bottom side, each of said razor blades being positioned in said razor well, each of said razor blades extending between said first lateral side and said second lateral side of said lateral bounding surface, said razor blades being spaced apart from each other and being distributed between said top side and said bottom side of said lateral bounding surface, said head having an opening extending through said back side and intersecting said razor well, said top end of said handle having a button well extending into said top end, said button well being aligned with said opening in said back side of said head, said handle having a hole extending through said handle and intersecting said button well; and
a cleaning unit being movably integrated into said head of said razor, said cleaning unit having a plurality of pushing elements each being positioned between respective pairs of said razor blades, said cleaning unit being actuatable into a cleaning position having each of said pushing elements traveling between said respective pair of razor blades wherein each of said pushing elements is configured to push hairs out from between said respective pair of razor blades, said cleaning unit being biased into a retracted position having each of said pushing elements being retracted from between said respective pair of razor blades, said cleaning unit comprising:
a button being positioned in said hole in said handle and extending into said button well, said button having a first end and a second end, said button having a lip extending laterally away from said button, said lip being aligned with said first end, said lip being positioned in said button well, said lip abutting a threshold between said button well and said hole thereby inhibiting said button from being removed from said button well;
a stem being coupled to said first end of said button and extending through said opening in said head, said stem having a distal end with respect to said first end of said button;
a panel having a first surface and a second surface, said first surface being coupled to said distal end of said stem such that said panel is positioned in said razor well;
a biasing member being positioned around said stem, said biasing member extending between said back side of said head and said first end of said button, said biasing member biasing said second end of said button outwardly through said hole in said handle such that said first surface of said panel rests against said lower bounding surface of said razor well, said panel travelling toward said front side of said head when said button is depressed; and
a plurality of cushions, each of said cushions being coupled to said second surface of said panel, each of said cushions being positioned between respective pairs of said razor blades such that each of said cushions defines a respective one of said pushing elements, each of said cushions travelling toward said front side of said head when said button is depressed wherein each of said cushions is configured to urge the hairs toward said front side of said head, each of said cushions being comprised of a deformable material such that said cushions are inhibited from deforming said razor blades when said button is depressed.
